(19) United States
(12) Patent Application Publication
(10) Pub. No.: US 2017/0165768 A1
(43) Pub. Date: Jun. 15, 2017

(54) TOOL FOR ROTARY-BREACHING WORKPIECES

(71) Applicant: Kennametal Inc., Latrobe, PA (US)

(72) Inventors: Josef K Herud, Herzogenaurach (DE); Arndt Hall, Weisendorf (DE); Markus Heinloth, Postbauer-Heng (DE); F.H. Erich Lill, Schwaig (DE); Sebastian Foettinger, Gunzenhausen (DE); Jan Grünler, Königshofen a. d. Heide (DE)

(21) Appl. No.: 15/310,051

(22) PCT Filed: May 11, 2015
(86) PCT No.: PCT/IB2015/053440

§ 371 Date: Nov. 9, 2016

(30) Foreign Application Priority Data
May 9, 2014 (DE) 102014106516.6

(51) Int. Cl. B23D 43/06; B23C 5/22

(52) U.S. Cl. CPC B23D 43/06; B23C 5/2234; B23C 2215/20; B23C 2270/025; B23D 2043/063

(57) ABSTRACT

The invention relates to a tool for rotary-broaching workpieces, having a support (10) which can be directly or indirectly attached to a machine tool and having multiple segments (12) which are secured to the support (10), wherein multiple receiving areas for cutting inserts are provided on each of the segments (12), and wherein a hydraulic clamping unit (42) is provided on the support (10) for each segment (12), said segment (12) being clampable on the support (10) by means of the clamping unit (42).

The invention relates to a tool for rotary-broaching workpieces, having a support which can be directly or indirectly attached to a machine tool and having multiple segments which are secured to the support, wherein multiple receiving areas for cutting inserts are provided on each of the segments.

Such tools for rotary-broaching workpieces are known from the prior art, in particular for machining crankshafts. An example is found in WO 2008/113 311 A1. In this tool, the segments are secured to the support by means of multiple screws. The screws engage the carrier radially in order to secure each segment to the support. Alternatively, the segments are secured to the support via a clamping device with an eccentric, wherein a clamping pin of the clamping device is also arranged radially in order to secure the segment to the support.

The object of the invention consists in developing the known tool in order to be able to attach the segments to the support with higher precision, and to be able to exchange the segments individually with little effort.

In order to solve this task, in a tool of the aforementioned type, a hydraulic clamping unit is provided on the support for each segment, said segment being clampable on the support by means of the clamping unit. Such a hydraulic clamping unit as a self-contained module can be attached to the support with little effort so that each segment can be clamped individually on the support with high clamping force.

It is preferably provided that the clamping unit comprises a clamping element that can be actuated from a lateral surface of the support, in particular in the form of a clamping screw. It is therefore not necessary to design the segments such that a tool can be attached through them to clamp the segments. Instead, the clamping unit can be actuated from the side, where it is easily accessible.

According to an embodiment of the invention, provided in the hydraulic clamping unit are multiple pressure pistons, in particular three pressure pistons, that can be actuated in parallel. In this way, the volume displacement of hydraulic fluid required for clamping the segments can be achieved with little effort, without having to provide a very long actuation travel in the axial direction in the hydraulic clamping unit for this purpose.

It is preferably provided that in the support are arranged multiple rams that can be charged by the hydraulic clamping unit, in particular two rams for each segment. The rams serve to mechanically relay the actuation force generated in the hydraulic clamping unit within the support. This prevents large volumes within the support from needing to be filled with hydraulic fluid.

A preferred embodiment of the invention provides that each segment is provided with multiple tension bolts, with which the rams engage such that the tension bolts—in particular two tension bolts—are driven into the support. The tension bolts extend suitably far into the support so that the actuation force generated by the hydraulic clamping unit is converted there into a clamping force, with which the respective segment is clamped tightly on the support.

Preferably provided between the rams and the associated tension bolts is a wedge gear that converts a displacement of the ram into a clamping movement of the tension bolt. The wedge gear allows for a displacement of the ram to be converted into a clamping movement of the tension bolt with little effort. For this purpose, only at least one wedge surface is required on the tension bolt, said wedge surface extending at an angle of >0 and <90° relative to the direction of displacement of the ram. By suitably selecting the orientation of the wedge surface, the transmission ratio of the wedge gear can be adapted to the respective requirements.

The preferred embodiment of the invention provides that each ram is sealed between its side facing the clamping unit and the support, such that the hydraulic fluid of the clamping unit stays within the clamping unit. This allows for the hydraulic clamping unit to be exchanged with little effort, without hydraulic fluid staying in the support and then being able to leak out. The maintenance effort overall is thereby significantly reduced.

It is preferably provided that the clamping unit is a self-contained assembly that is mounted onto the support. If the hydraulic clamping unit needs to be maintained or repaired, after loosening a few mounting screws the clamping unit can be removed from the support as a complete unit and be replaced by a new clamping unit.

A mechanical snap-in connection that can be disconnected manually and with which the segment can be fixed onto the support is preferably provided. The snap-in connection serves to fix the corresponding segment provisionally onto the support, before the hydraulic clamping device is actuated or after it has been loosened. This prevents the segment from detaching undesirably from the support during assembly and disassembly.

It is preferably provided that the inside radius of the segment is slightly larger in the initial condition than the outside radius of a receiving area on the support, to which receiving area the segment is secured. The different radii result in the segment being slightly bent elastically to a smaller inside radius when it is clamped on the support, which ensures that it uniformly rests on the perimeter of the support.

Advantageous embodiments of the invention result from the dependent claims.

The invention will be explained below with reference to an embodiment that is portrayed in the accompanying drawings. In the drawings:

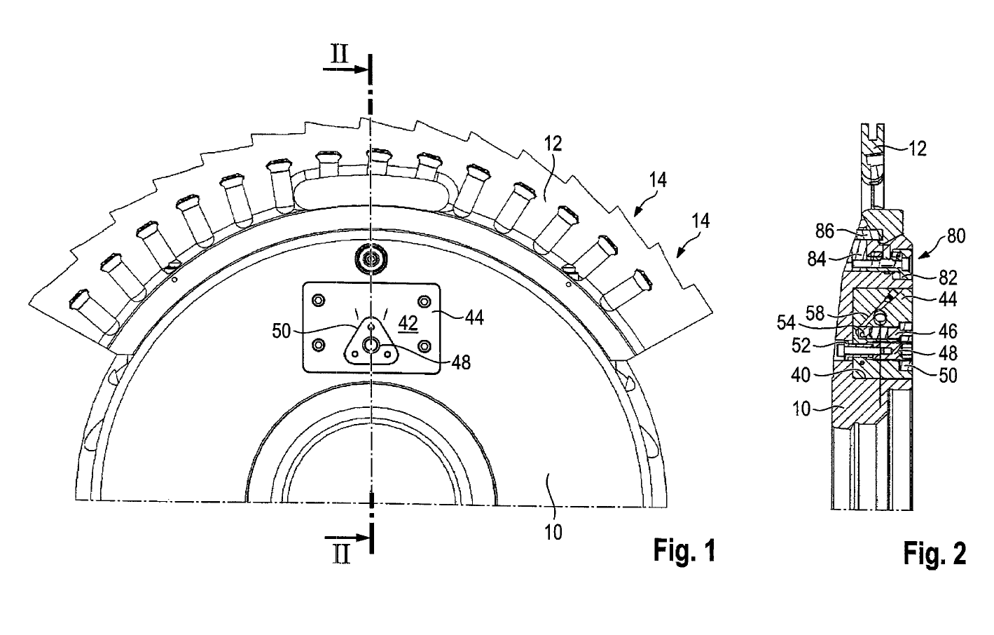

FIG. 1 shows a schematic, truncated lateral view of a support with a segment arranged therein;

FIG. 2 shows a section along line II-II of FIG. 1;

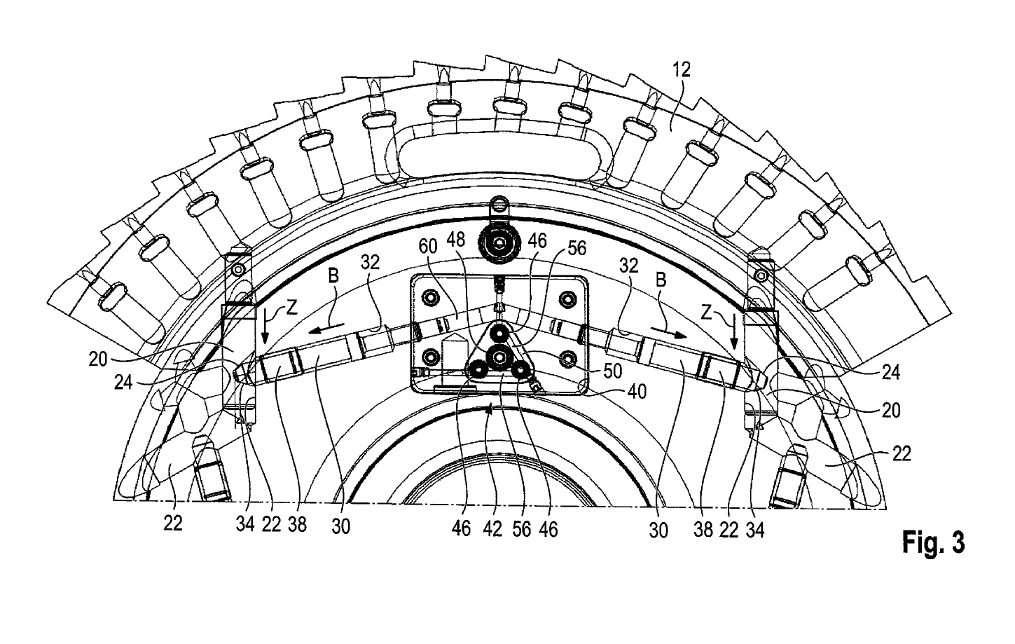

FIG. 3 shows a schematic partial view of the support with the segment of FIG. 1, wherein the components located inside are visible; and

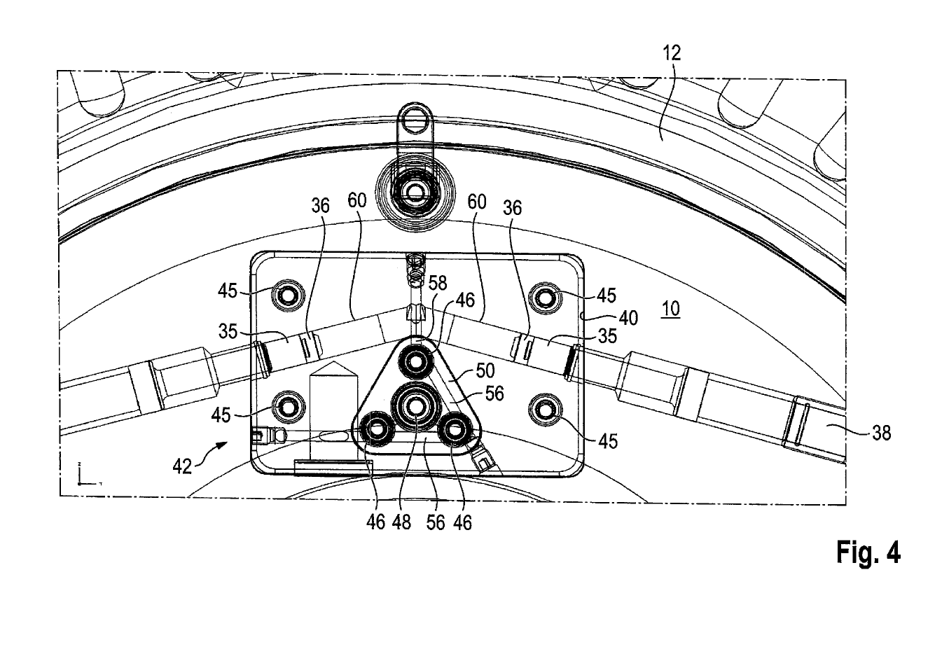

FIG. 4 shows a section of FIG. 3 on an enlarged scale.

FIG. 1 shows a support 10 which can be directly or indirectly attached to a machine tool. On the support 10, multiple segments 12 can be attached, of which only a single one is shown here. Each of the segments comprises multiple receiving areas 14 into which cutting inserts can be applied either directly or indirectly via cassettes. When the support 10 is completely populated with segments and these segments in turn are completely populated with cutting inserts, a tool for rotary-broaching workpieces is formed with which crankshafts can be machined, for example.

Each segment 12 is provided with multiple tension bolts 20 (see FIG. 3) that are screwed to the segment 12 to secure it to the support. The tension bolts 20 extend parallel to one another and—in this case—parallel to a center plane that, when viewed in the circumferential direction, extends through the center of the segment and through the axis of rotation of the support 10. In the exemplary embodiment shown, two tension bolts 20 are used per segment 12. Each tension bolt 20 extends within a respective guide bore 22 in the support 10.

Furthermore arranged within the support 10 are multiple rams 30 that generally extend from a receiving area 40 (arranged centrally for each segment 12) for a hydraulic clamping unit 42 (explained in detail below) to the guide bores 22 in order to interact there with the tension bolts 20. Similarly to the tension bolts 20, the rams 30 are borne in guide bores 32 in the support so as to be movable.

Each ram 30 interacts with its associated tension bolt 20 by means of a wedge gear that is formed by a wedge surface 24 on the tension rod 20 and an actuating surface 34 on the ram 30. The wedge surface 24 and the actuation surface 34 are oriented relative to each other such that an adjusting movement of the ram 30 in the direction of the arrow B results in a clamping force being exerted on the corresponding tension bolt 20, said clamping force acting in the direction of the arrow Z. With respect to FIG. 3, when the rams 30 are pressed outward away from each other, the tension bolts 20 are thus pulled downward, whereby a clamping force is exerted on the respective segment 12.

Each ram 30 is provided at its side facing the hydraulic clamping unit 42 with a guide extension 35, to which a seal 36 is attached. Furthermore, return springs 38 (indicated schematically here) are provided which charge the ram 30 away from the guide bore 22 in the direction toward the hydraulic clamping unit 42.

The hydraulic clamping unit 42 is provided in order to move the rams 30 in the direction of the arrows B. Said clamping unit is designed as a self-contained assembly (see also FIG. 2) that can be inserted into the receiving area 40 in the support 10.

The hydraulic clamping unit 42 comprises a base body 44 that is secured in the support 10 by means of multiple mounting screws 45.

Multiple pressure pistons 46 are arranged in the base body 44. In the embodiment shown, three pressure pistons 46 are used that are arranged uniformly around a clamping element 48 such that they define an equilateral triangle, in the center of which is arranged the clamping element 48. The clamping element 48 is designed in this instance as a clamping screw, the head of which is accessible from a lateral surface of the support 10.

The pressure pistons 46 are mounted on a pressure plate 50, the position of which is defined by the clamping screw 48 in the axial direction relative to the axis of rotation of the support 10. When the clamping screw 48 is tightened, the pressure plate 50 that is arranged on an outer face of the hydraulic clamping unit 42 is moved into said clamping unit 42, whereby the pressure pistons 46 are also moved into the base body 44 of the hydraulic clamping unit 42.

In the embodiment shown, the clamping screw 48 is designed as a differential screw that engages with a threaded hole in the base body 44 via a first threaded section (which is to the left with respect to FIG. 2) and with a threaded hole of the pressure plate 50 via a second, oppositely threaded section (arranged on the right with respect to FIG. 2). In this way, comparably high forces can be exerted on the pressure plate 50 with low clamping torques.

The clamping screw 48 is provided with a stop 52 which determines how far the clamping screw can be unscrewed from the base body 44.

Each of the pressure pistons 46 is arranged in a pressure chamber 54, the pressure chambers 54 being connected to one another via connection channels 56 and to a connecting line 60 via a connecting channel 58. The connecting line 60 extends from two opposite outer faces of the base body 44 toward the center, wherein each side of the connecting chamber 60 is designed as an extension of the guide bores 32 in which the rams 30 are arranged.

The support 10 is moreover provided with a mechanical snap-in mechanism 80 that can be disconnected manually and that serves to provisionally secure a segment to the support. The snap-in mechanism 80 comprises an actuating element 82 that can be actuated manually (in this case, a screw) and that is connected to a locking element 84 (see FIG. 2). In the unactuated position shown in FIG. 2, the actuating element 82 is charged into the locking position together with the locking element 84 by a return spring (not shown), in which locking position the locking element 84 engages a locking bolt 86 that is provided on the segment 12. If the actuating element 82 is pushed toward the left with respect to FIG. 2, the locking element 84 releases the locking bolt 86.

In order to secure a segment 12 to the support 10, this segment 12 is arranged on the support 10 such that the tension bolts 20 are located in the guide bores 22. The pre-fixing of the segment 12 on the support 10 is carried out by means of the snap-in mechanism 80, with which the segment 12 can be pre-mounted so far onto the support that it cannot fall off the support unintentionally, even if it is not otherwise clamped by the tension bolts 20.

After the tension bolts 20 engage in the guide bores 22, the clamping element 48 can be actuated such that the pressure pistons 46 are slid into the associated pressure chambers via the pressure plate 50. A hydraulic fluid present in the pressure chambers is thereby displaced out of the pressure chambers into the connecting line 60, where it acts on the rams 30 and moves them in the direction of the arrows B. This adjusting movement is converted into a clamping movement along the direction Z of the clamping bolts 20 via the wedge gear formed by the wedge surface 24 and the actuation surface 34. The respective segment 12 is thereby firmly clamped on the outer perimeter of the corresponding support.

For a uniform clamping effect it is advantageous that the inside radius of each segment is slightly larger than the outside radius of the surface on the support 10 on which the segment is clamped. In the initial condition, each segment 12 can thus “tilt” on the support 10 before the tension bolts 20 are clamped, namely about a point that is located approximately in the region of the snap-in mechanism 80. The action of the tension bolts 20 during clamping slightly elastically deforms the corresponding segment 12 so that it finally comes to abut with its entire inner surface against the outer surface of the support 10.

When the segment 12 is to be removed again, the clamping element 48 is loosened so that hydraulic fluid can flow back into the pressure chambers. This is facilitated by the return springs 38, which charge the rams 30 toward the hydraulic clamping unit 42, whereby the tension bolts 20 are released.

As can be seen in particular in FIG. 4, the rams 30 engage in the base body 44 of the hydraulic clamping unit 42 with their ends facing away from the tension bolts 20.

This ensures that no hydraulic fluid is present in the support 10 itself. In particular during an exchange of the hydraulic clamping unit 42, it is advantageous that the support 10 is “dry” so that there is no problem with larger volumes of hydraulic fluid that would need to be removed from the support 10 after the clamping unit is removed.

In order to exchange the hydraulic clamping unit 42, the rams 30 are pulled outward from the outer faces of the support, against the action of the return spring 38, so far that they no longer engage in the base body 44 of the hydraulic clamping unit 42. This clamping unit 42 can then be removed laterally from the receiving area 40 after loosening the mounting screws 45.

1. A tool for rotary-broaching workpieces comprising: a support which can be directly or indirectly attached to a machine too;
multiple segments which are secured to the support, with multiple receiving areas for cutting inserts are provided on each of the segments; and
a hydraulic clamping unit is provided on the support for each segment, said segment being clampable on the support by means of the clamping unit.

2. The tool according to claim 1, wherein the clamping unit comprises a clamping screw that can be actuated from a lateral surface of the support.

3. The tool according to claim 1, wherein at least three pressure pistons are provided in the hydraulic clamping unit that can be actuated in parallel.

4. The tool according to claim 1, wherein the support has multiple rams that can be charged by the hydraulic clamping unit.

5. The tool according to claim 4, wherein each segment is provided with at least two tension bolts with which the rams can engage such that the tension bolts are charged into the support.

6. The tool according to claim 4, wherein a wedge gear is provided between the rams and the associated tension bolts that converts a displacement of the ram into a clamping movement of the tension bolt.

7. The tool according to claim 4, wherein each ram is sealed between a side of the ram facing the clamping unit and the support so that the hydraulic fluid of the clamping unit stays within said clamping unit.

8. The tool according to claim 1, wherein the clamping unit is a self-contained assembly that is mounted onto the support.

9. The tool according to claim 1, wherein a mechanical snap-in mechanism is provided that can be released manually and with which the segment can be fixed to the support.

10. The tool according to claim 1, wherein an inside radius of the segment is slightly larger in an initial condition than an outside radius of a receiving area on the support to which receiving area the segment is secured.

11. The tool according to claim 4, wherein the support has two rams for each segment.
